(19) United States
(12) Patent Application Publication
(10) Pub. No.: US 2019/0261079 A1
(43) Pub. Date: Aug. 22, 2019

(54) EARPHONE AND SUPPORTER

(71) Applicant: JVC KENWOOD CORPORATION, Yokohama-shi (JP)

(72) Inventors: Koji OKAWA, Yokohama-shi (JP); Masaki TAKEI, Yokohama-shi (JP); Masashi UEMOTO, Yokohama-shi (JP); Hiromitsu ASAKA, Yokohama-shi (JP); Toshiyuki HIMURO, Yokohama-shi (JP)

(21) Appl. No.: 16/274,840

(22) Filed: Feb. 13, 2019

(30) Foreign Application Priority Data
Feb. 20, 2018 (JP) 2018-027851

(51) Int. Cl. H04R 1/10

(52) U.S. Cl. CPC H04R 1/1016; H04R 1/1066; H04R 2201/109; H04R 1/1075; H04R 1/105

(57) ABSTRACT

An earphone includes a main body and an arm protruding outward in a radial direction of the main body and being capable of coming into contact with and biasing an inner wall of a pinna in a fitted state where the main body is fitted into a cavum concha of the pinna. The arm includes an easily-deformable portion which deforms more easily than other portions of the arm.

### CROSS REFERENCE TO RELATED APPLICATION

This application is based upon and claims the benefit of priority from the prior Japanese Patent Application No. 2018-027851 (filing date: Feb. 20, 2018), the entire contents of which are incorporated herein by reference.

### TECHNICAL FIELD

The present invention relates to an earphone and a supporter.

### RELATED ART

Among earphones, there is known an earphone including a fitting assisting portion which protrudes in an arm shape from a main body and comes into contact with and presses a wall in the pinna to improve the fitting to the pinna (see Japanese Patent Application Publication No. 2002-058086). In Japanese Patent Application Publication No. 2002-058086, a retaining portion corresponds to the fitting assisting portion. Moreover, the fitting assisting portion is also called supporter.

The supporter which is the fitting assisting portion is made of silicone rubber or the like to be soft so that excellent fitting feeling can be obtained. However, the softer the supporter is, the more likely the supporter is to elastically deform. In this case, the pressing force against the pinna inner wall decreases and it is difficult to improve the fitting of the earphone. Meanwhile, the harder the supporter is, the less likely the supporter is to elastically deform. In this case, the pressing force against the pinna inner wall increases and the fitting of the earphone is improved. However, this may cause pain in the pinna with the fitting of the earphone. Moreover, since the shape of the pinna varies among individuals, it is difficult to set the softness of the supporter to suit each user irrespective of the pinna shape of the user. Accordingly, there is a demand for some ingenuity to improve fitting of an earphone to the pinna.

### SUMMARY

An object of the present invention is to provide an earphone and a supporter whose fitting is improved irrespective of a pinna shape.

An earphone according to first aspect of the present invention includes a main body and an arm protruding outward in a radial direction of the main body and being capable of coming into contact with and biasing an inner wall of a pinna in a fitted state where the main body is fitted into a cavum concha of the pinna. The arm includes an easily-deformable portion which deforms more easily than other portions of the arm.

A supporter according to second aspect of the present invention is capable of being attached to and detached from a main body of an ear phone. The supporter includes an arm configured to be attached to the main body and being capable of coming into contact with and biasing an inner wall of a pinna in a fitted state where the main body is fitted into a cavum concha of the pinna. The arm includes an easily-deformable portion which deforms more easily than other portions of the arm.

The earphone and the supporter according to the aspects of the present invention provide an earphone and a supporter whose fitting is improved irrespective of a pinna shape.

### BRIEF DESCRIPTION OF DRAWINGS

FIG. 1 is a perspective view illustrating an earphone A51 which is Example 1 of an earphone according to an embodiment of the present invention;

FIG. 2 is an assembly view illustrating attachment of a supporter A1 which is Example 1 of a supporter according to the embodiment of the present invention to a main body 31 of the earphone A51;

FIG. 3 is a perspective view illustrating the supporter A1;

FIG. 4 is a perspective view for explaining a fitting state of the earphone A51 to the pinna 60;

FIG. 5 is a side view which is partially illustrated as a cross-sectional view to explain the fitting state of FIG. 4;

FIG. 6 is a perspective view illustrating an earphone B51 which is Example 2 of an earphone according to the embodiment of the present invention;

FIG. 7 is an assembly view illustrating attachment of a supporter B1 which is Example 2 of the supporter according to the embodiment of the present invention to the main body 31 of the earphone B51;

FIG. 8 is a perspective view illustrating the supporter B1;

FIG. 9 is a perspective view for explaining a fitting state of the earphone B51 to the pinna 60;

FIG. 10 is a side view which is partially illustrated as a cross-sectional view to explain a fitting process of FIG. 9;

FIG. 11 is a perspective view illustrating an earphone C51 which is Example 3 of an earphone according to the embodiment of the present invention;

FIG. 12 is an assembly view illustrating attachment of a supporter C1 which is Example 3 of the supporter according to the embodiment of the present invention to the main body 31 of the earphone C51;

FIG. 13 is a perspective view illustrating the supporter C1;

FIG. 14 is a perspective view for explaining a fitting state of the earphone C51 to the pinna 60; and

FIG. 15 is a graph for explaining deformation resistance of the supporter A1.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Description will be hereinbelow provided for embodiments of the present invention by referring to the drawings. It should be noted that the same or similar parts and components throughout the drawings will be denoted by the same or similar reference signs, and that descriptions for such parts and components will be omitted or simplified. In addition, it should be noted that the drawings are schematic and therefore different from the actual ones.

An earphone according to an embodiment of the present invention is described by using earphones A51 to C51 of Examples 1 to 3.

### (Example 1)

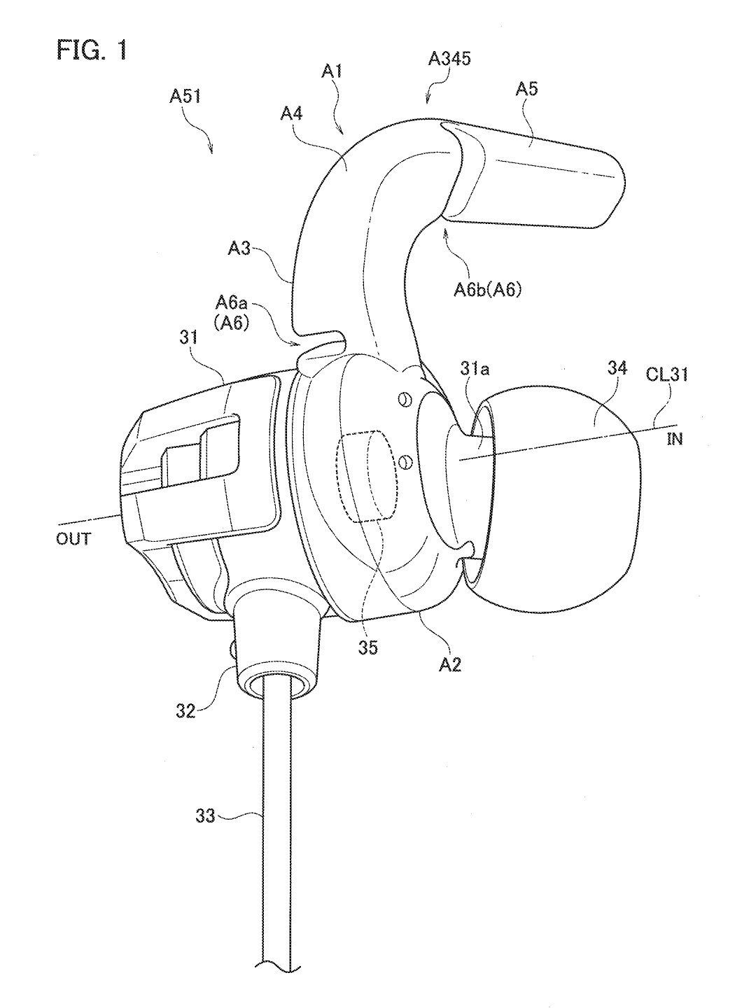

FIG. 1 is a perspective view illustrating the earphone A51 of Example 1. The earphone A51 is a so-called earplug type (canal type) earphone and is for the left ear. The earphone A51 includes a substantially-cylindrical main body 31 which houses therein a speaker unit 35 and a cord 33 whose one end is connected to the speaker unit 35 and which is led out from the main body 31 through a bushing 32. A sound tube portion 31a is formed on one end side of the main body 31 to protrude while being tilted relative to an axis CL31 of the main body 31 toward the face when the earphone A51 is worn on the pinna. An earpiece 34 which is to be inserted into the ear canal is detachably attached to a distal end of the sound tube portion 31a. In the following description, the side where the sound tube portion 31a protrudes in the axis CL31 direction is referred to as IN and the opposite side is referred to as OUT for the sake of convenience (see FIG. 1).

The main body 31 is made of a resin such as, for example, polycarbonate (PC) and the bushing 32 and the earpiece 34 are made of, for example, silicone rubber.

The earphone A51 converts an audio signal received from an external audio reproduction device or the like via the cord 33 into sound by using the speaker unit 35 and outputs the sound from a distal end of the sound tube portion 31a to the outside.

A supporter A1 is detachably attached to a root part of the sound tube portion 31a protruding from the main body 31. Although the supporter A1 may be integral with the main body 31, the case where the supporter A1 is a separate body is described herein. The supporter A1 is fitted to the main body 31 by using a well-known attachment-detachment structure. Examples of the structure include a tight-fit type, a snap-fit type, a bayonet type, and the like.

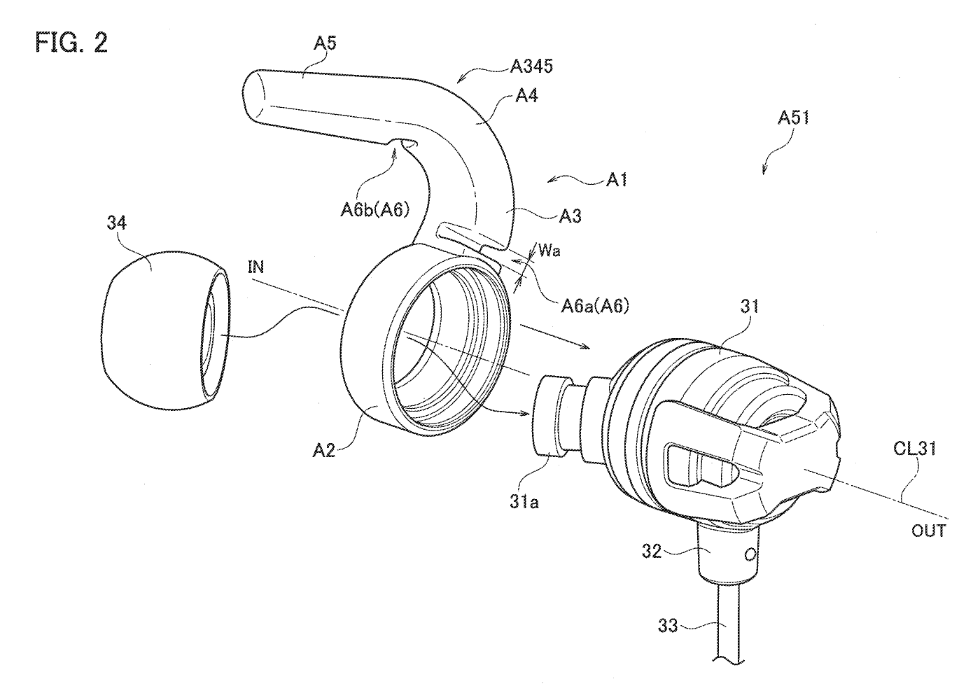

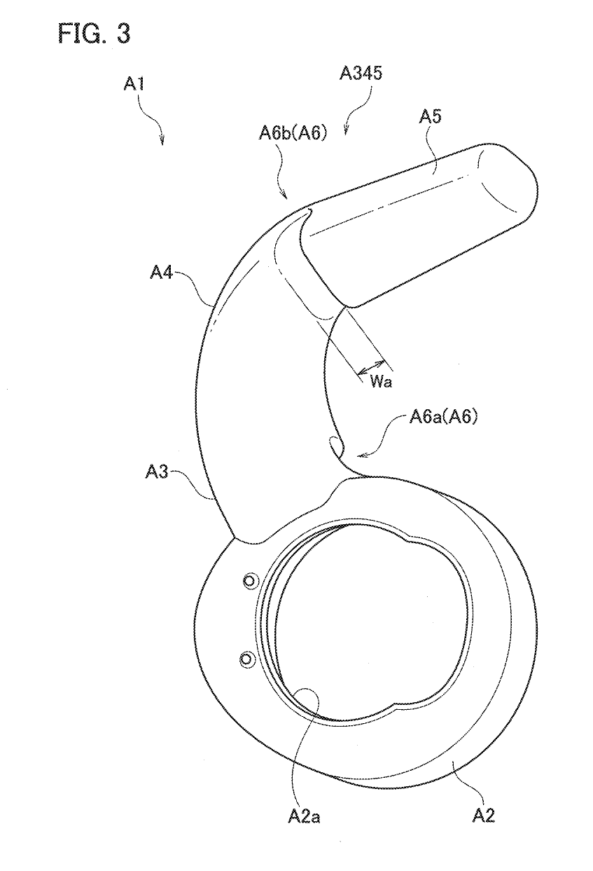

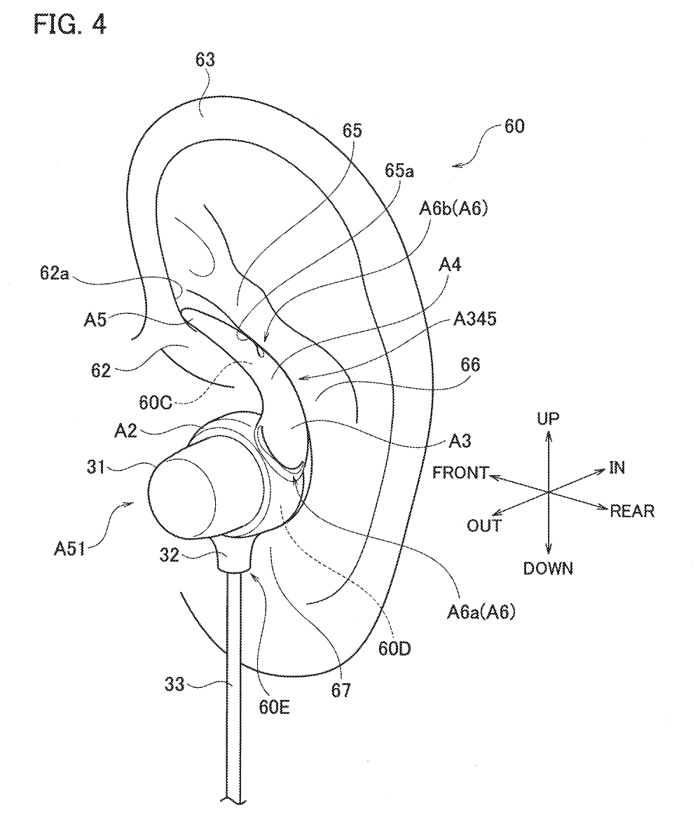

Next, details of the supporter A1 are described with reference to FIGS. 2 to 4. FIG. 2 is an assembly view illustrating a state where the supporter A1 and the earpiece 34 are attached to the main body 31, FIG. 3 is a perspective view of only the supporter A1, and FIG. 4 is a view illustrating a usage state where the earphone A51 is fitted to the pinna 60.

The supporter A1 includes an annular base portion A2 which detachably engages with the main body 31 and an arm A345 which extends outward from the base portion A2 in a radial direction of the base portion A2. Moreover, the arm A345 includes a root portion A3, an intermediate portion A4, and a distal end portion A5 in this order from the root side. Specifically, the arm A345 includes the root portion A3 which stands upright in the radial direction of the main body 31, the intermediate portion A4 which is bent at an angle of about 90° from an end portion of the root portion A3 on the outer side, in a direction toward the face in the case where the earphone A51 is used, and the distal end portion A5 which substantially linearly extends from an end portion of the intermediate portion A4 on the outer side, in the state where the supporter A1 is attached to the main body 31. The curvature of the intermediate portion A4 is set such that the intermediate portion A4 extends along the antihelix 66 of the pinna 60.

The supporter A1 is made of, for example, silicone rubber and the arm A345 is flexible and has a soft surface.

The supporter A1 has groove portions A6 which are grooves cut in the arm A345. The depth of each groove is, for example, about half the thickness of the arm A345. Moreover, as illustrated in FIG. 2, the height of an opening of each groove is referred to as opening width Wa. The extending direction and the cut direction of each groove portion A6 are a direction orthogonal to the axis of a portion of the arm A345 in which the groove portion A6 is provided in this example, but may obliquely intersect the axis. In the arm A345, the groove portions A6 are formed as easily-deformable portions which can be more easily bent to more greatly deform than other portions when the same bending deformation force is applied thereto.

In this example, the groove portions A6 which are the easily-deformable portions are provided in two portions. Specifically, the groove portions A6 include a groove portion A6a cut from the OUT side toward the IN side in the root portion A3 and a groove portion A6b cut from the IN side toward the OUT side near a position of a border between the intermediate portion A4 and the distal end portion A5. In this example, the depth of each groove portion A6 is set to be about half the thickness of the portion where the groove portion A6 is provided in the arm A345 and the opening width Wa is set to be about ⅛ of the thickness.

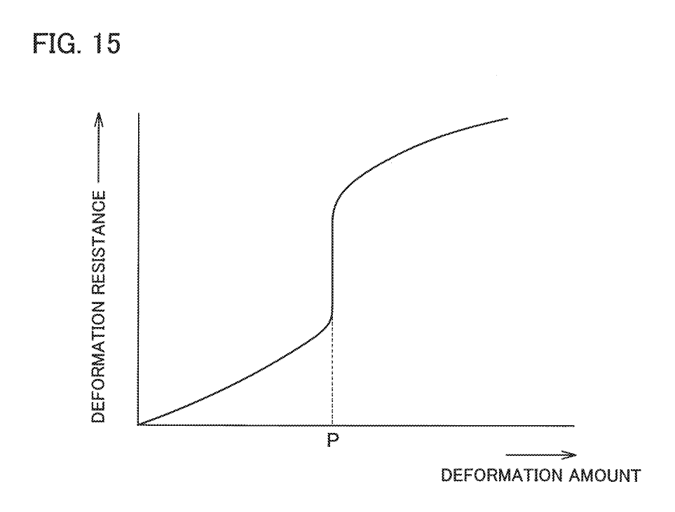

The cross-sectional area of each groove portion A6 is smaller than those in other portions (non-groove portions) and is about half in this example. Accordingly, when the arm A345 warps, not the non-groove portions but the groove portions A6 mainly deform and warp. FIG. 15 is a schematic graph illustrating a relationship between a deformation amount (horizontal axis) and a deformation resistance (vertical axis) in the case where the portions of the arm A345 where the groove portions A6 are provided are warped such that the groove portions A6 close.

As illustrated in the graph of FIG. 15, the deformation resistance is relatively small in the initial stage of the deformation and gradually increases with an increase in the deformation amount. When the warp amount reaches a value P, the deformation resistance abruptly increases. The range from the value P and higher is a state where the opening portions of the groove portions A6 are closed and peripheral portions thereof are in contact (the opening width Wa is zero). The deformation angle in this state is about 15°, provided that the depth of each groove portion A6 is about half the thickness of the portion of the arm A345 near the groove portion A6 and the opening width Wa is about ⅛ of the thickness of this portion as described above.

As described above, providing the groove portions A6 in the supporter A1 allows the supporter A1 to behave in two stages in warping and deforming of the arm A345 in terms of the deformability, specifically, the arm A345 deforms with a small force and is thus easily deformable while the groove portions A6 are open in the initial stage of deformation, and is less deformable after the groove portions A6 close. When the intermediate portion A4 deforms toward the OUT side relative to the root portion A3, the groove portion A6a provided in the root portion A3 and opening toward the OUT side causes the supporter A1 to behave in two stages. Meanwhile, when the distal end portion A5 deforms toward the IN side relative to the intermediate portion A4, the groove portion A6b provided near the border between the intermediate portion A4 and the distal end portion A5 and opening toward the IN side causes the supporter A1 to behave in two stages.

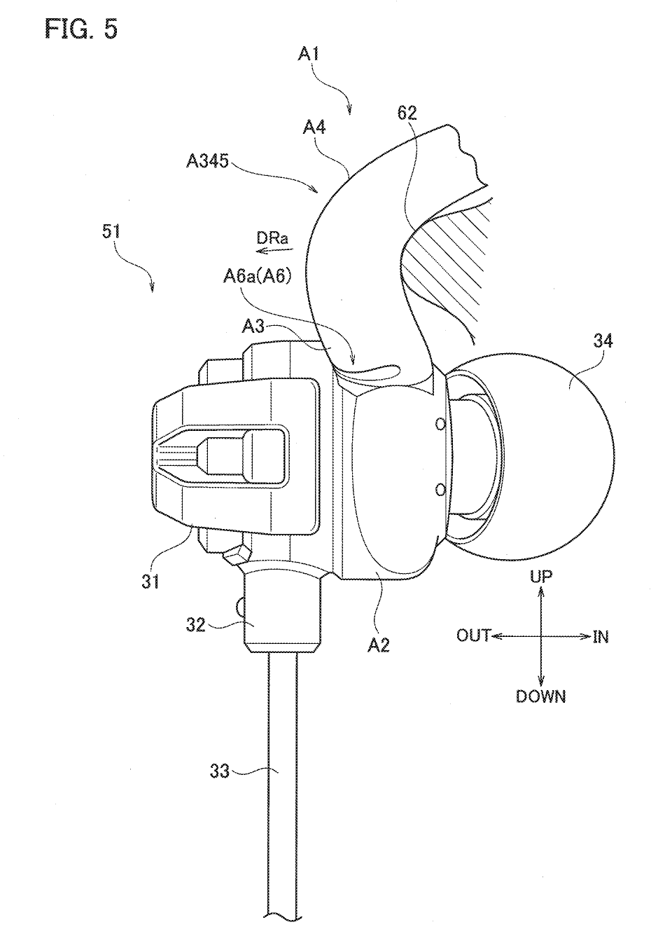

In view of this, the fitting of the earphone A51 to the pinna 60 is described with reference to FIGS. 4 and 5. In FIG. 4, the directions of up, down, front, and rear are defined as illustrated by the arrows. FIG. 4 illustrates a state where the earphone A51 is fitted to the pinna 60 and is in a stable position. Hereafter, this state is referred to as fitted state. Prior to the fitting of the earphone A51 to the pinna 60, as illustrated in FIG. 2, the supporter A1 is attached to the main body 31 by being engaged therewith and the earpiece 34 is attached to the sound tube portion 31a by being fitted thereto.

In the fitted state, the earphone A51 is in a position where the bushing 32 and the cord 33 are led out downward through the intertragic notch 60E of the pinna 60. The earpiece 34 is inserted into the ear canal not illustrated in FIG. 4. The base portion A2 of the supporter A1 is housed in the cavum concha 60D of the pinna 60 and the arm A345 is housed in the pinna 60 by extending from the cavum concha 60D over the crus of helix 62 to pass through the cymba concha 60C thereabove while coming into contact with the rear inner wall 65a of the inferior crus of antihelix 65 to bias it such that the distal end portion A5 pushes forward the inner wall 62a inside the crus of helix 62.

FIG. 5 is a partially cross-sectional side view (rear view) illustrating a state where the arm A345 extends over the crus of helix 62. As illustrated in FIG. 5, when the main body 31 of the earphone A51 is pushed toward the IN side with the finger for fitting, a portion of the arm A345 from the root portion A3 to the intermediate portion A4 is pushed toward the OUT side by the crus of helix 62 and deforms (see arrow DRa). When the deformation amount increases and reaches the value P in the groove portion A6a, the opening of the groove portion A6a provided to open toward the OUT side closes and the peripheral portions thereof come into contact as illustrated in FIG. 5. The deformation resistance thereby abruptly increases and the deformation is prevented.

Meanwhile, in FIG. 4, since the distal end portion A5 is housed in the rear wall of the crus of helix 62, the movement thereof toward the OUT side is restricted and the intermediate portion A4 tries to deform toward the OUT side by riding over the crus of helix 62. When the amount of this deformation increases and reaches the value P in the groove portion A6b, the groove portion A6b provided to open toward the IN side closes and the deformation resistance abruptly increases, thereby preventing deformation. As described above, in the fitting of the arm A345, since the groove portions A6a, A6b close and the arm A345 becomes less elastically deformable depending on the deformation amount, the arm A345 can surely maintain the main body 31 in the fitted state and prevent it from falling out from the pinna 60 and the fitting and the fitting feeling are improved. Since the arm A345 is substantially soft and easily elastically deformable until the deformation amounts in the groove portions A6a, A6b reach the value P, the arm A345 is designed to match pinnae of various shapes and be fitted thereto.

### (Example 2)

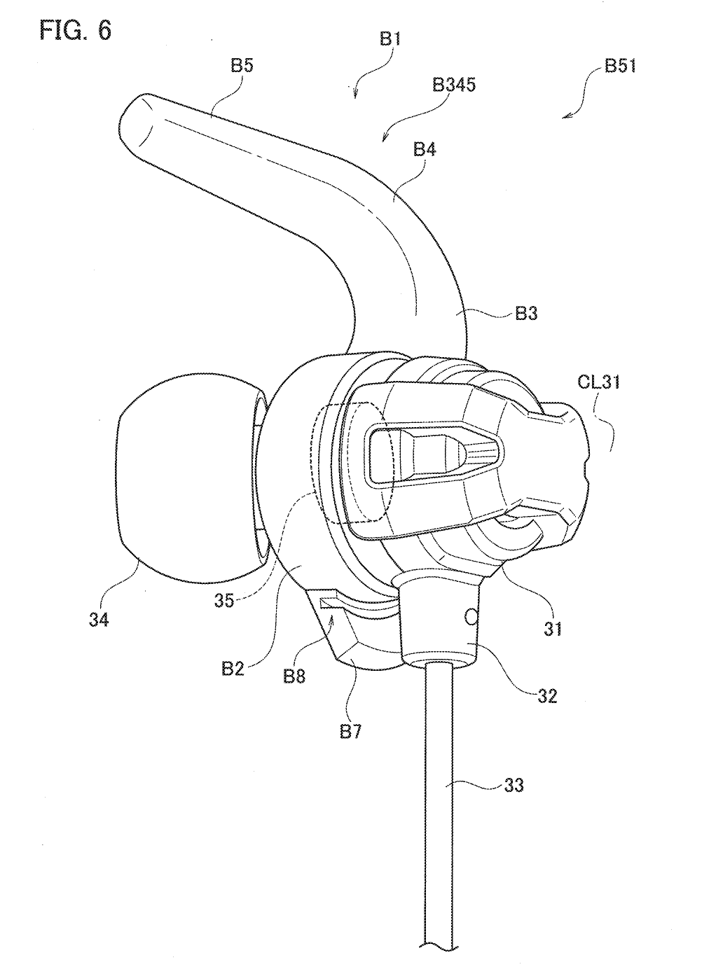

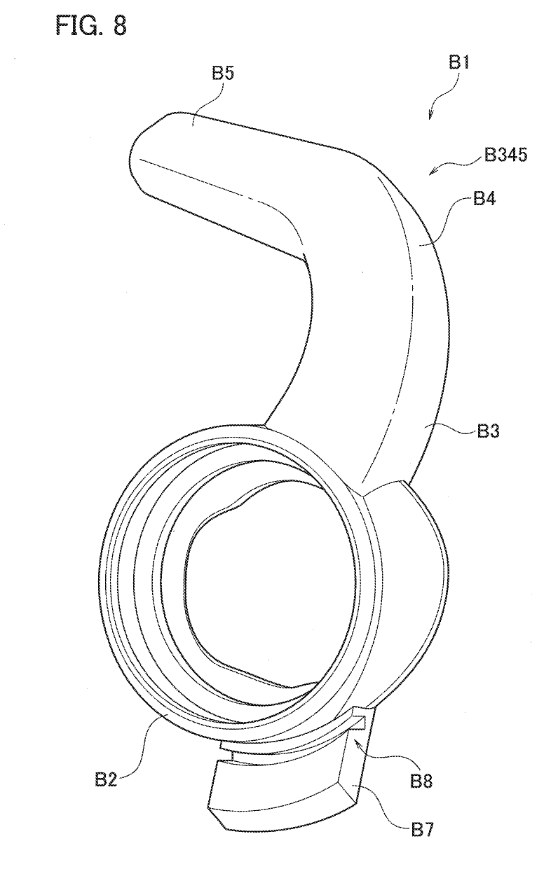

FIG. 6 is a perspective view illustrating the earphone B51 of Example 2. The earphone B51 is a so-called earplug type (canal type) earphone and is for the left ear. The earphone B51 is an earphone in which the supporter A1 in the earphone A51 is replaced by a supporter B1 and the other portions are the same as those in the earphone A51. The supporter B1 different from Example 1 is thus described with reference to FIGS. 6 to 8. OUT and IN are the same as those in Example 1 and are defined as illustrated in FIG. 6.

The supporter B1 includes an annular base portion B2 which detachably engages with the main body 31, an arm B345 which extends outward from the base portion B2 in a radial direction of the base portion B2, and a wall portion B7 which is formed at a circumferential position on the base portion B2 opposite to an extending position of the arm B345 and which extends in the circumferential direction of the base portion B2 while protruding outward in the radial direction of the base portion B2. The arm B345 is the supporter A1 without the groove portions A6 and includes a root portion B3, an intermediate portion B4, and a distal end portion B5 in this order from the root side. Specifically, the arm B345 includes the root portion B3 which extends outward from the main body 31 in the radial direction thereof, the intermediate portion A4 which is bent at an angle of about 90° from an end portion of the root portion B3 on the outer side, in a direction toward the face in the case where the earphone B51 is used, and the distal end portion B5 which substantially linearly extends from an end portion of the intermediate portion B4 on the outer side, in this order from the root side in the state where the supporter B1 is attached to the main body 31. The curvature of the intermediate portion B4 is set such that the intermediate portion A4 extends along the antihelix 66 of the pinna 60.

The supporter B1 is made of, for example, silicone rubber and the arm B345 and the wall portion B7 are flexible and have soft surfaces.

The supporter B1 has a groove portion B8 extending along the base portion B2 in the circumferential direction thereof near the root of the wall portion B7. The groove portion B8 is formed as a portion which deforms more easily than the other portions of the wall portion B7 (portion which deforms more greatly when the same bending deformation force is applied thereto). The groove portion B8 is cut from the OUT side to the IN side, has a depth of about ⅔ of the thickness of the wall portion B7, and is formed over the entire width of the wall portion B7 in the circumferential direction of the base portion B2.

The supporter B1 behaves in two stages such that the deformation resistance in the case where the wall portion B7 is deformed to be tilted toward the OUT side is low until the opening of the groove portion B8 closes and is high after the closing, as in the case of the groove portion A6 of Example 1 illustrated in FIG. 15.

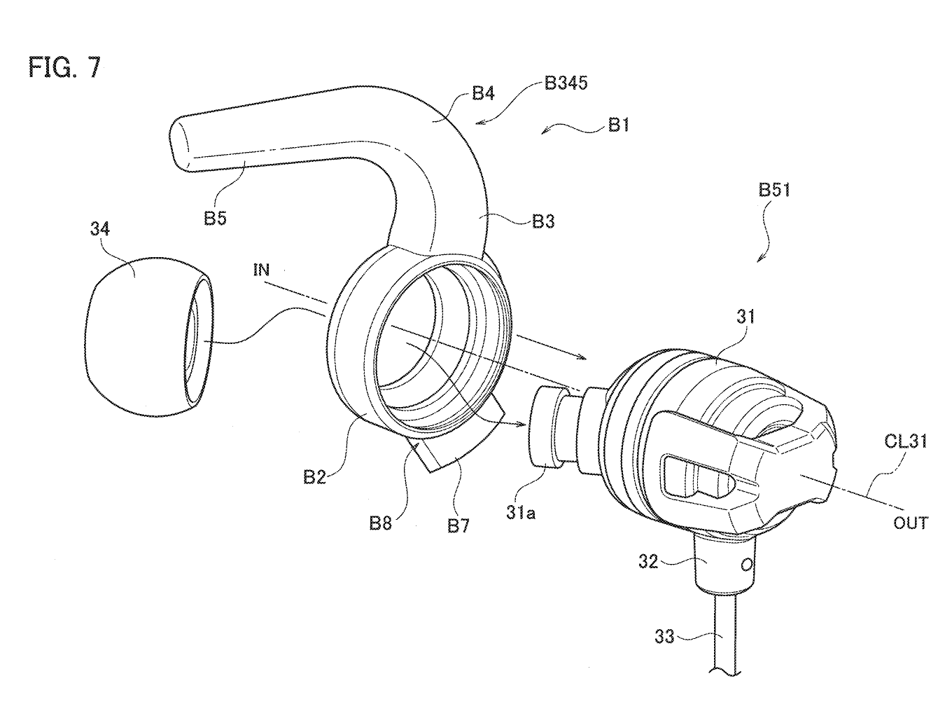

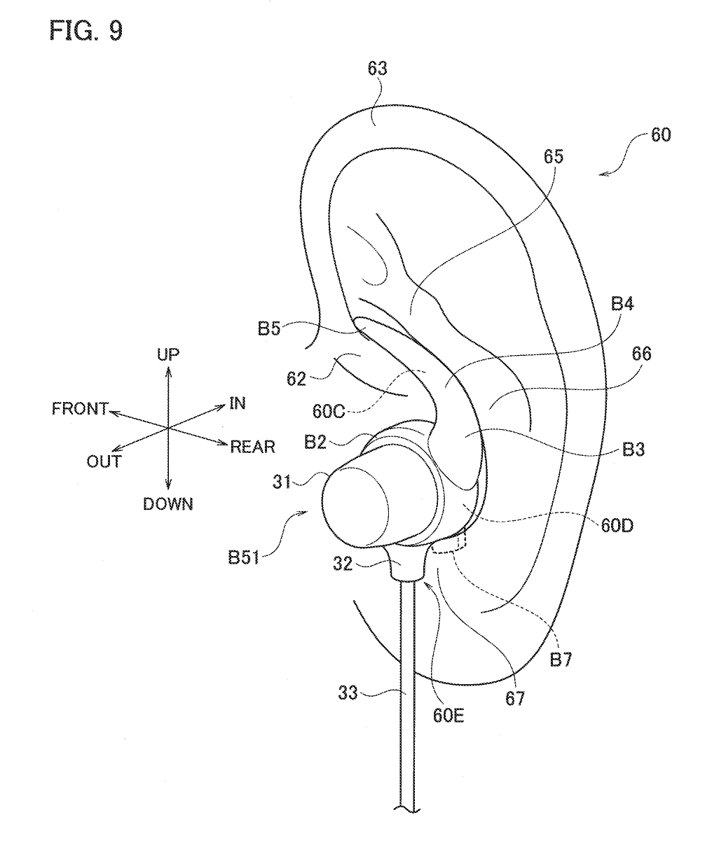

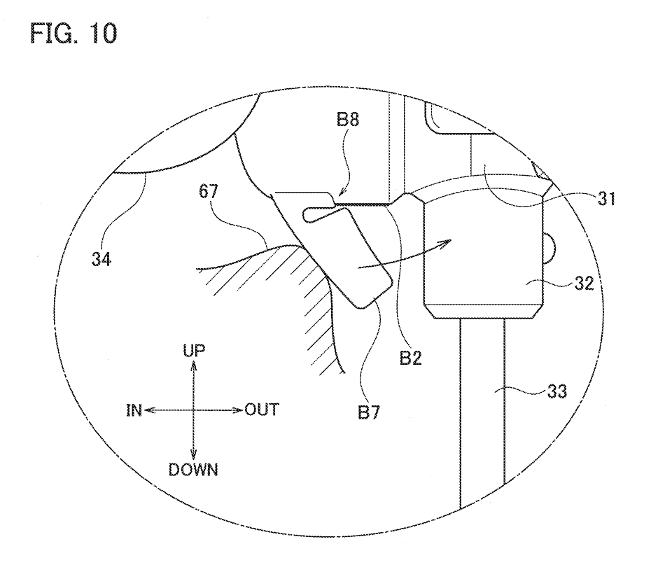

In view of this, the fitting of the earphone B51 to the pinna 60 is described with reference to FIGS. 9 and 10. The directions of up, down, front, and rear are as illustrated in FIG. 9. FIG. 9 illustrates a fitted state where the earphone B51 is fitted to the pinna 60 and is in a stable position. Prior to the fitting of the earphone B51 to the pinna 60, as illustrated in FIG. 7, the supporter B1 is attached to the main body 31 by being engaged therewith and the earpiece 34 is attached to the sound tube portion 31a by being fitted thereto. The supporter B1 is fitted to the main body 31 by using a well-known attachment-detachment structure like the supporter A1.

The base portion B2 of the supporter B1 is housed in the cavum concha 60D of the pinna 60. The arm B345 is housed by extending from the cavum concha 60D over the crus of helix 62 to pass through the cymba concha 60C thereabove while coming into contact with the rear inner wall 65a of the inferior crus of antihelix 65 to bias it such that the distal end portion B5 pushes forward the inner wall 62a inside the ems of helix 62.

Meanwhile, the wall portion B7 is housed in the cavum concha 60D inside the antitragus 67 by riding over the antitragus 67 in a lower portion of the pinna 60. In this fitting, when the wall portion B7 rides over the antitragus 67, as illustrated in FIG. 10, the wall portion B7 deforms to tilt toward the OUT side. In this case, since the opening of the groove portion B8 closes and the deformation resistance abruptly increases, the wall portion B7 is less elastically deformable. Accordingly, the arm B345 is pushed upward and surely presses the inner wall 65a (lower wall) of the inferior crus of antihelix 65 and a preferable housing position is provided irrespective of the pinna shape. Moreover, after the wall portion B7 rides over the antitragus 67 and is housed in the cavum concha 60D, the wall portion B7 is pressed downward based on a resilient force applied to the arm B345 from the inner wall of the inferior crus of antihelix 65. In this case, since the groove portion B8 is closed and the wall portion B7 is less elastically deformable, the earphone B51 is fitted in a stable position. As described above, providing the wall portion B7 in the supporter B1 allows the earphone B51 to match pinnae of various shapes and improves the fitting thereof.

### (Example 3)

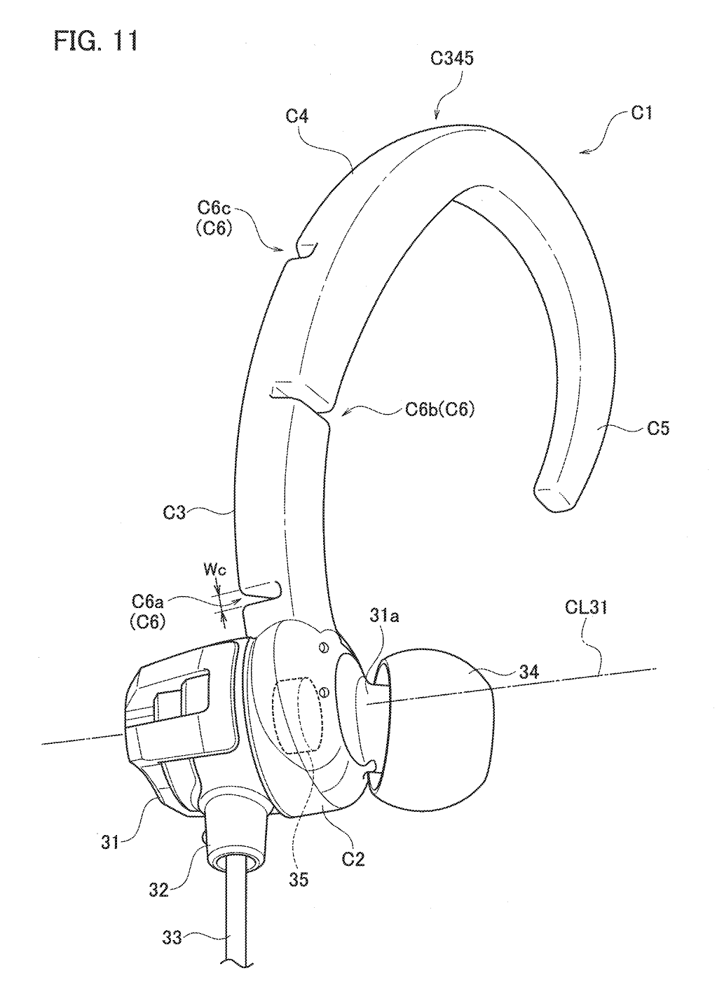

FIG. 11 is a perspective view illustrating the earphone C51 of Example 3. The earphone C51 is a so-called earplug type (canal type) earphone and is for the left ear. The earphone C51 is an earphone in which the supporter A1 in the earphone A51 is replaced by a supporter C1 and the other portions are the same as those in the earphone A51. The supporter C1 different from Example 1 is thus described with reference to FIGS. 11 to 14. OUT and IN are the same as those in Example 1 and are defined as illustrated in FIG. 11.

The supporter C1 includes an annular base portion C2 which detachably engages with the main body 31 and an arm C345 which extends outward from the base portion C2 in a radial direction of the base portion C2. Moreover, the arm C345 includes a root portion C3, an intermediate portion C4, and a distal end portion C5 in this order from the root side. Specifically, the arm C345 includes the root portion C3 which extends outward from the main body 31 in the radial direction thereof, the intermediate portion C4 which is connected to the root portion C3 and which gradually curves in a direction toward the face in the case where the earphone C51 is used, the distal end portion C5 which is connected to the intermediate portion C4 and which is bent in an inverted U-shape such that a distal end side thereof faces the main body 31, in a state where the supporter C1 is attached to the main body 31. The curvature of the distal end portion C5 is set such that the distal end portion C5 extends along the inner wall of the helix 63 of the pinna 60.

The supporter C1 is made of, for example, silicone rubber and the arm C345 is flexible and has a soft surface.

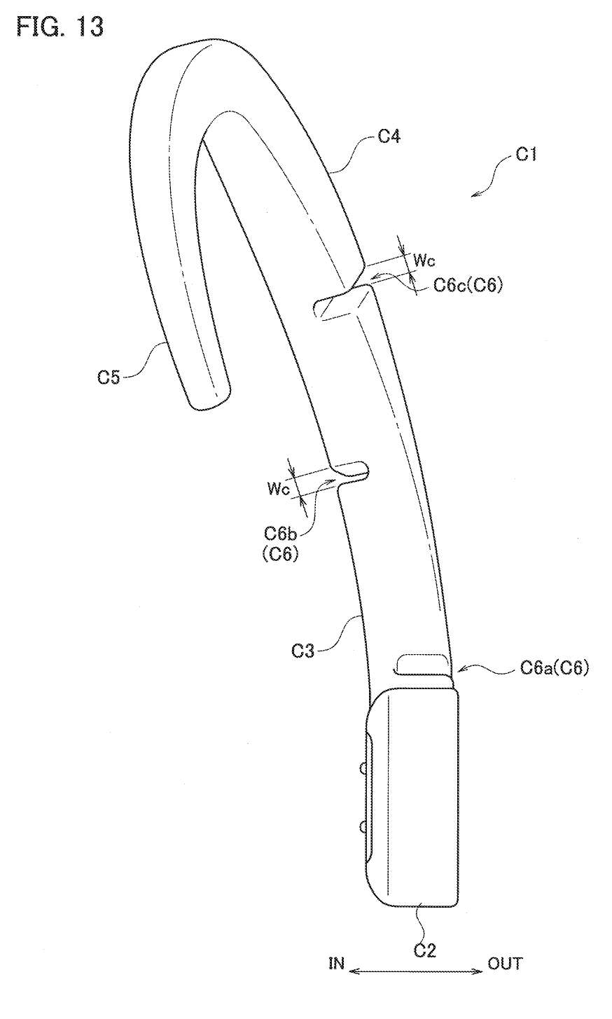

The supporter C1 has groove portions C6 which are grooves cut in the arm C345. The groove portions C6 are formed as portions which deform more easily than the other portions of the arm C345 (portions which deform more greatly when the same bending deformation force is applied thereto). The depth of each groove is, for example, about half the thickness of the arm C345. Moreover, as illustrated in FIG. 13, the width of an opening of each groove is referred to as opening width Wc. The extending direction and the cut direction of each groove portion C6 are a direction orthogonal to the axis of a portion of the arm C345 in which the groove portion C6 is provided in this example, but may obliquely intersect the axis.

In this example, the groove portions C6 are provided in three portions. Specifically, the groove portions C6 include a groove portion C6a cut from the OUT side toward the IN side in the root portion C3, a groove portion C6b cut from the IN side toward the OUT side in the intermediate portion C4, and a groove portion C6c cut from the OUT side toward the IN side in the intermediate portion C4, in this order from the base portion C2 side. In this example, the depth of each groove portion C6 is set to be about half the thickness of a portion near the groove portion C6 in the arm C345 and the opening width Wc is set to be about ⅛ of the thickness.

The supporter C1 behaves in two stages such that the deformation resistance in the case where the groove portion C6 is deformed to be collapsed on the opening side is low until the opening of the groove portion C6 closes and is high after the closing, as in the case of the groove portion A6 of Example 1 illustrated in FIG. 15.

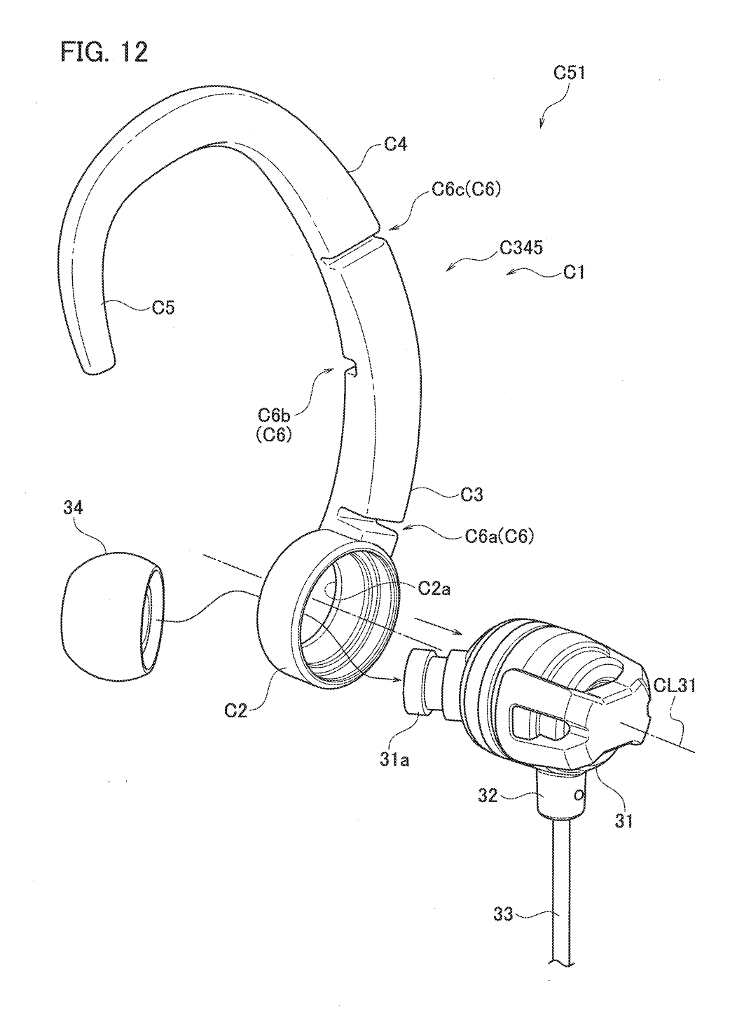

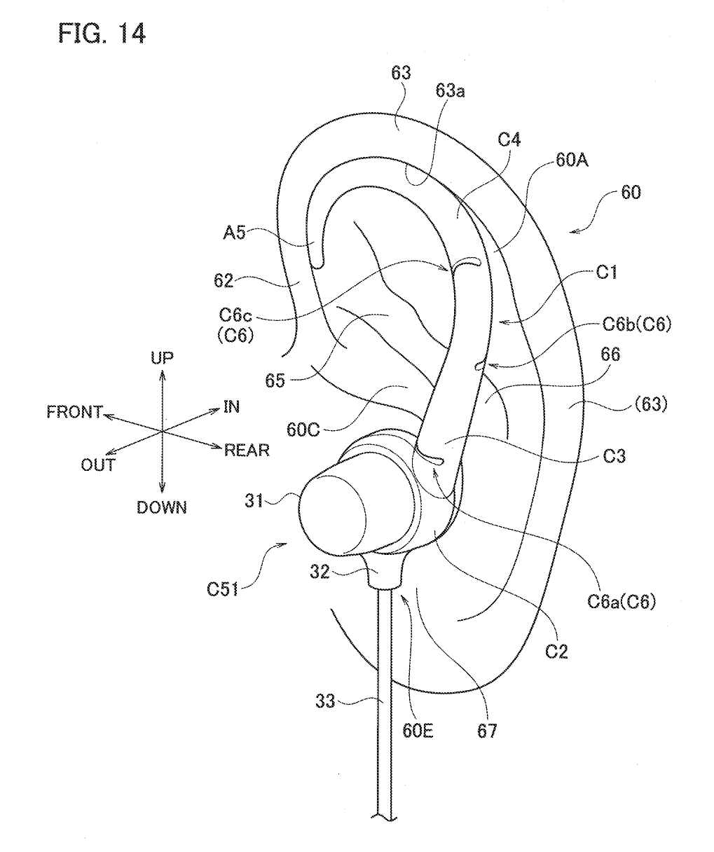

In view of this, the fitting of the earphone C51 to the pinna 60 is described with reference to mainly FIG. 14. In FIG. 14, the direction of up, down, front, and rear are as illustrated by the arrows. FIG. 14 illustrates a fitted state where the earphone C51 is fitted to the pinna 60 and is in a stable position. Prior to the fitting of the earphone C51 to the pinna 60, as illustrated in FIG. 12, the supporter C1 is attached to the main body 31 by being engaged therewith and the earpiece 34 is attached to the sound tube portion 31a by being fitted thereto.

In the fitted state, the earphone C51 is in a position where the bushing 32 and the cord 33 are led out downward through the intertragic notch 60E of the pinna 60. The earpiece 34 is inserted into the ear canal, although not illustrated in FIG. 14. The base portion C2 of the supporter C1 is housed in the cavum concha 60D of the pinna 60. The arm C345 is housed in the pinna 60 by extending from the cavum concha 60D over the crus of helix 62 and the antihelix 66 to reach the scapha 60A thereabove such that the distal end portion C5 curves along the inner wall 63a the helix 63 on the inside and reaches the crus of helix 62.

A portion of the arm C345 from the root portion C3 to the intermediate portion C4 is deformed by being pushed toward the OUT side by the ems of helix 62. In the groove portion C6a, the deformation amount thereby reaches the value P and the opening closes. The deformation resistance thus increases and this portion of the arm C345 becomes less elastically deformable. Meanwhile, since the distal end portion C5 curves along the inner wall of the helix 63 and reaches the crus of helix 62 to hold on thereto, the groove portion C6c deforms in such a direction that the opening thereof closes. Then, when the deformation amount reaches the value P and the opening closes, the deformation resistance increases and the distal end portion C5 becomes less elastically deformable. Accordingly, in the fitting to the pinna 60, the arm C345 becomes less elastically deformable depending on the deformation amount and can maintain the main body 31 in the fitted state and prevent it from falling out from the pinna 60.

Moreover, when the difference in height between the scapha 60A and the antihelix 66 of the arm C345 is small due to differences in the pinna 60 among the individuals, the groove portion C6c of the arm C345 restricts excessive deformation of the arm C345 in the closing direction of the groove portion C6c by means of the aforementioned two-stage behavior. As described above, in the fitting of the arm C345, since groove portions C6a to C6c close and the arm C345 becomes less elastically deformable depending on the deformation amount, the arm C345 can surely maintain the main body 31 in the fitted state and prevent it from falling out from the pinna 60 and the fitting and the fitting feeling are improved. Since the arm C345 is substantially soft and easily elastically deformable until the deformation amounts in the groove portions C6a to C6c reach the value P, the arm C345 is designed to match pinnae of various shapes and be fitted thereto.

Although the aforementioned earphones A51 to C51 are described as earphones for the left ear, the earphones A51 to C51 can be used for the right ear by reversing the shapes in the front-rear direction to have shapes symmetric with respect to the vertical axis.

The examples described above in detail are not limited to aforementioned configurations and may be modified as modified examples within a scope not departing from the spirit of the present invention.

Each of the supporters A1 to C1 may be formed integrally with the main body 31. Making the supporters A1 to C1 replaceable as in Examples 1 to 3 allows a user to select a supporter depending on the application and preference of the user and the usability is thereby improved.

The earphones A51 to A53 are not limited to the canal type earphones. The earphones A51 to A53 may be so-called inner ear type earphones which include no sound tube portion 31a or earpiece 34 and which are used with only the main body 31 housed in the pinna 60.

The wall portion B7 in Example 2 may be applied to Examples 1 and 3. Although the groove portions A6, B6, C6 which make the cross-sectional area smaller than the other portions are described as examples of the easily-deformable portion, the easily-deformable portion is not limited to this. For example, the easily-deformable portion may be a portion made of a material softer than the other portions.

What is claimed is:

1. An earphone comprising:
a main body; and
an arm protruding outward in a radial direction of the main body and being capable of coming into contact with and biasing an inner wall of a pinna in a fitted state where the main body is fitted into a cavum concha of the pinna, wherein
the arm includes an easily-deformable portion which deforms more easily than other portions of the arm.

2. An earphone according to claim 1, wherein the easily-deformable portion is a groove portion having a cross-section area of the arm smaller than in the other portions of the arm.

3. The earphone according to claim 2, wherein the groove portion is formed such that an opening of the groove portion is on the head side in the fitted state.

4. The earphone according to claim 2, wherein the groove portion is formed such that an opening of the groove portion is on the opposite side to the head side in the fitted state.

5. A supporter capable of being attached to and detached from a main body of an ear phone, the supporter comprising an arm configured to be attached to the main body and being capable of coming into contact with and biasing an inner wall of a pinna in a fitted state where the main body is fitted into a cavum concha of the pinna, wherein
the arm includes an easily-deformable portion which deforms more easily than other portions of the arm.

6. The supporter according to claim 5, wherein the easily-deformable portion is a groove portion having a cross-section area of the arm smaller than in the other portions of the arm.

7. The supporter according to claim 6, wherein the groove portion is formed such that an opening of the groove portion is on the head side in the fitted state.

8. The supporter according to claim 6, wherein the groove portion is formed such that an opening of the groove portion is on the opposite side to the head side in the fitted state.
